(19) United States
(12) Patent Application Publication
(10) Pub. No.: US 2016/0381320 A1
(43) Pub. Date: Dec. 29, 2016

(54) METHOD, APPARATUS, AND COMPUTER PROGRAM PRODUCT FOR PREDICTIVE CUSTOMIZATIONS IN SELF AND NEIGHBORHOOD VIDEOS

(71) Applicant: Nokia Technologies Oy, Espoo (FI)

(72) Inventors: Sujeet Shyamsundar Mate, Tampere (FI); Igor Danilo Diego Curcio, Tampere (FI)

(21) Appl. No.: 15/192,320

(22) Filed: Jun. 24, 2016

Related U.S. Application Data
(60) Provisional application No. 62/184,744, filed on Jun. 25, 2015.

(51) Int. Cl. H04N 7/01; G06K 9/46; G06T 3/40; G06K 9/62

(52) U.S. Cl. CPC H04N 7/0117; G06K 9/6267; G06K 9/4671; G06T 3/40

(57) ABSTRACT

A method, apparatus, and computer program product are provided for enhanced customization for smart video rendering of high resolution immersive content on devices with lower resolution displays. A method is provided that includes receiving first instance default region of interest data for a first instance of content; receiving first instance region of interest customization interaction data for the first instance of the content; receiving second instance default region of interest data for a second instance of the content; determining customization similarity detection for the second instance of the content based on the first instance default region of interest data, the first instance region of interest customization interaction data, and the second instance default region of interest data; generating predicted customized region of interest data for the second instance of the content; and providing an indication of the predicted customized region of interest data.

### CROSS REFERENCE TO RELATED APPLICATION

The present application claims priority to U.S. Provisional Patent Application No. 62/184,744 filed Jun. 25, 2015, the contents of which are incorporated in their entirety herein.

### TECHNOLOGICAL FIELD

An example embodiment of the present invention relates generally to smart video rendering, and more specifically, to enhanced customization for smart video rendering of high resolution immersive content.

### BACKGROUND

When playing a higher resolution video file on a device with a lower resolution display, current media players scale the media resolution to the display resolution, for example, when playing a high definition (HD) video file on a device with a Quarter Video Graphics Array (QVGA) display. Some other types of HD video content where smart video rendering may be used include immersive video content, 360-degree panoramic (stereoscopic and monoscopic) video, omnidirectional video, and the like. This smart video rendering may reduce the subjective value of the video due to the scaling. Different objects of interest (OOIs) may have different value in the viewer's perspective. The “smart rendering” of the HD video file is performed in a way that includes the most relevant portions of the video. The decrease in the size of the one or more OOIs can be reduced drastically by cropping away less important portions of the video. Instead, the most relevant parts can be highlighted without loss of quality (or with limited loss of quality). This smart rendering can be done automatically using different types of analysis techniques, as illustrated in FIG. 1. FIG. 1 illustrates example full video frames (wide angle frames) as images 1, 3, and 6 and example rendered close up frames as images 2, 4, and 5.

A problem inherent with automatic smart video rendering generation systems is that it is difficult for an automatic analysis system to perfectly determine the subjective interest based solely on objective information. In addition, it is difficult to incorporate all different object detectors, due to difficulties in their availability as well as the increase in the computing time as well as resource use, with the addition of new object of interest detectors, for example, detecting a dancer's feet, detecting a guitar held by an artist, etc.

The problem is equally relevant, and even more pronounced, for devices that record omnidirectional immersive content. The applicability of the predictive customization is likely to be higher for omnidirectional content captured by multiple devices in an event or location of interest, due to the higher probability of field of view overlap between the different capture devices.

Embodiments of the present invention address this problem in an automatic smart video rendering generation system. Embodiments of the present invention provide methods for reducing the number of customizations for creating a smart video rendering with minimal effort.

### BRIEF SUMMARY

Methods, apparatuses, and computer program products are therefore provided according to example embodiments of the present invention to provide enhanced customization for smart video rendering of high resolution immersive content on devices with lower resolution displays.

In one embodiment, a method is provided that at least includes receiving default region of interest data for a first instance of a content stream; receiving region of interest customization interaction data for the first instance of the content stream; receiving default region of interest data for a second instance of the content stream; determining, by a processor, customization similarity detection for the second instance of the content stream based on the first instance default region of interest data, the first instance region of interest customization interaction data, and the second instance default region of interest data; generating, by the processor, predicted customized region of interest data for the second instance of the content stream; and providing indications of the predicted customized region of interest data.

In some embodiments, the method further includes wherein the default region of interest data comprises spatio-temporal coordinates of the default region of interest; and one or more object of interest positions within the default region of interest; and wherein the region of interest customization interaction data comprises spatio-temporal coordinates of a customized region of interest; and one or more object of interest positions within the customized region of interest.

In some embodiments, the method further includes wherein the customization similarity detection comprises comparing the first instance default region of interest data to the second instance default region of interest data to determine if the first instance default region of interest and the second instance default region of interest are within a threshold distance of each other.

In some embodiments, the method further includes wherein if the first instance default region of interest and the second instance default region of interest are within a threshold distance of each other, generating predicted customized region of interest data for the second instance comprises determining a region of interest for the second instance which is spatially similar to a customized region of interest for the first instance based on the first instance region of interest customization interaction data.

In some embodiments, the method further includes determining one or more significant objects of interest in the first instance of content and the second instance of content; determining a relationship between the one or more significant objects of interest in the first instance to the first instance default region of interest and the first instance customized region of interest; and modifying the second instance predicted customized region of interest based on the first instance relationship and a relative position of the one or more significant objects of interest in the second instance.

In some embodiments, the method further includes wherein the default region of interest data further comprises temporal coordinates for one of the audio rhythm or the pattern content.

In some embodiments, the method further includes wherein the predicted customized region of interest data comprises spatio-temporal coordinates of a predicted customized region of interest.

In some embodiments, the method further includes wherein the predicted customized region of interest data comprises spatio-temporal coordinates of multiple predicted customized regions of interest.

In another embodiment, an apparatus is provided that includes at least one processor and at least one memory including computer program instructions with the at least one memory and the computer program instructions configured to, with the at least one processor, cause the apparatus at least to receive default region of interest data for a first instance of a content stream; receive region of interest customization interaction data for the first instance of the content stream; receive default region of interest data for a second instance of the content stream; determine customization similarity detection for the second instance of the content stream based on the first instance default region of interest data, the first instance region of interest customization interaction data, and the second instance default region of interest data; generate predicted customized region of interest data for the second instance of the content stream; and provide indications of the predicted customized region of interest data.

In some embodiments, the apparatus further comprises wherein the default region of interest data comprises: spatio-temporal coordinates of the default region of interest; and one or more object of interest positions within the default region of interest; and wherein the region of interest customization interaction data comprises: spatio-temporal coordinates of a customized region of interest; and one or more object of interest positions within the customized region of interest.

In some embodiments, the apparatus further comprises wherein the customization similarity detection comprises comparing the first instance default region of interest data to the second instance default region of interest data to determine if the first instance default region of interest and the second instance default region of interest are within a threshold distance of each other.

In some embodiments, the apparatus further comprises wherein if the first instance default region of interest and the second instance default region of interest are within a threshold distance of each other, generating predicted customized region of interest data for the second instance comprises determining a region of interest for the second instance which is spatially similar to a customized region of interest for the first instance based on the first instance region of interest customization interaction data.

In some embodiments, the apparatus further comprises the at least one memory and the computer program instructions, with the at least one processor, causing the apparatus at least to: determine one or more significant objects of interest in the first instance of content and the second instance of content; determine a relationship between the one or more significant objects of interest in the first instance to the first instance default region of interest and the first instance customized region of interest; and modify the second instance predicted customized region of interest based on the first instance relationship and a relative position of the one or more significant objects of interest in the second instance.

In some embodiments, the apparatus further comprises wherein the default region of interest data further comprises temporal coordinates for one of the audio rhythm or the pattern content.

In some embodiments, the apparatus further comprises wherein the predicted customized region of interest data comprises spatio-temporal coordinates of a predicted customized region of interest.

In some embodiments, the apparatus further comprises wherein the predicted customized region of interest data comprises spatio-temporal coordinates of multiple predicted customized regions of interest.

In another embodiment, a computer program product is provided that includes at least one non-transitory computer-readable storage medium bearing computer program instructions embodied therein for use with a computer with the computer program instructions including program instructions, when executed, causing an apparatus to receive default region of interest data for a first instance of a content stream; receive region of interest customization interaction data for the first instance of the content stream; receive default region of interest data for a second instance of the content stream; determine customization similarity detection for the second instance of the content stream based on the first instance default region of interest data, the first instance region of interest customization interaction data, and the second instance default region of interest data; generate predicted customized region of interest data for the second instance of the content stream; and provide indications of the predicted customized region of interest data.

In some embodiments, the computer program product further comprises wherein the default region of interest data comprises: spatio-temporal coordinates of the default region of interest; and one or more object of interest positions within the default region of interest; and wherein the region of interest customization interaction data comprises: spatio-temporal coordinates of a customized region of interest; and one or more object of interest positions within the customized region of interest.

In some embodiments, the computer program product further comprises wherein the customization similarity detection comprises comparing the first instance default region of interest data to the second instance default region of interest data to determine if the first instance default region of interest and the second instance default region of interest are within a threshold distance of each other.

In some embodiments, the computer program product further comprises wherein if the first instance default region of interest and the second instance default region of interest are within a threshold distance of each other, generating predicted customized region of interest data for the second instance comprises determining a region of interest for the second instance which is spatially similar to a customized region of interest for the first instance based on the first instance region of interest customization interaction data.

In some embodiments, the computer program product further comprises the computer program instructions comprising program instructions, when executed, causing the computer at least to: determine one or more significant objects of interest in the first instance of content and the second instance of content; determine a relationship between the one or more significant objects of interest in the first instance to the first instance default region of interest and the first instance customized region of interest; and modify the second instance predicted customized region of interest based on the first instance relationship and a relative position of the one or more significant objects of interest in the second instance.

In some embodiments, the computer program product further comprises wherein the default region of interest data further comprises temporal coordinates for one of the audio rhythm or the pattern content.

In some embodiments, the computer program product further comprises wherein the predicted customized region of interest data comprises spatio-temporal coordinates of a predicted customized region of interest.

In some embodiments, the computer program product further comprises wherein the predicted customized region of interest data comprises spatio-temporal coordinates of multiple predicted customized regions of interest.

In another embodiment, an apparatus is provided that includes at least means for receiving default region of interest data for a first instance of a content stream; means for receiving region of interest customization interaction data for the first instance of the content stream; means for receiving default region of interest data for a second instance of the content stream; means for determining customization similarity detection for the second instance of the content stream based on the first instance default region of interest data, the first instance region of interest customization interaction data, and the second instance default region of interest data; means for generating predicted customized region of interest data for the second instance of the content stream; and means for providing indications of the predicted customized region of interest data.

In another embodiment, a method is provided that at least includes receiving video content customization metadata and neighborhood metadata from a first customization device, wherein the neighborhood metadata comprises data regarding other video content captured in the same vicinity; determining, by a processor, that the customization metadata is associated with first captured content that is similar to second captured content to be customized, based at least in part on the neighborhood metadata; performing, by the processor, customization similarity detection for the second captured content based on the customization metadata; generating, by the processor, predicted customized region of interest data for the second captured content based on the customization similarity detection and the customization metadata; and providing indications of the predicted customized region of interest data.

In another embodiment, an apparatus is provided that includes at least one processor and at least one memory including computer program instructions, the at least one memory and the computer program instructions, with the at least one processor, causing the apparatus at least to: receive video content customization metadata and neighborhood metadata from a first customization device, wherein the neighborhood metadata comprises data regarding other video content captured in the same vicinity; determine that the customization metadata is associated with first captured content that is similar to second captured content to be customized, based at least in part on the neighborhood metadata; perform customization similarity detection for the second captured content based on the customization metadata; generate predicted customized region of interest data for the second captured content based on the customization similarity detection and the customization metadata; and provide indications of the predicted customized region of interest data.

In another embodiment, a computer program product is provided that includes at least one non-transitory computer-readable storage medium bearing computer program instructions embodied therein for use with a computer, the computer program instructions comprising program instructions, when executed, causing the computer at least to: receive video content customization metadata and neighborhood metadata from a first customization device, wherein the neighborhood metadata comprises data regarding other video content captured in the same vicinity; determine that the customization metadata is associated with first captured content that is similar to second captured content to be customized, based at least in part on the neighborhood metadata; perform customization similarity detection for the second captured content based on the customization metadata; generate predicted customized region of interest data for the second captured content based on the customization similarity detection and the customization metadata; and provide indications of the predicted customized region of interest data.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 illustrates example video frames from an example smart video rendering process;

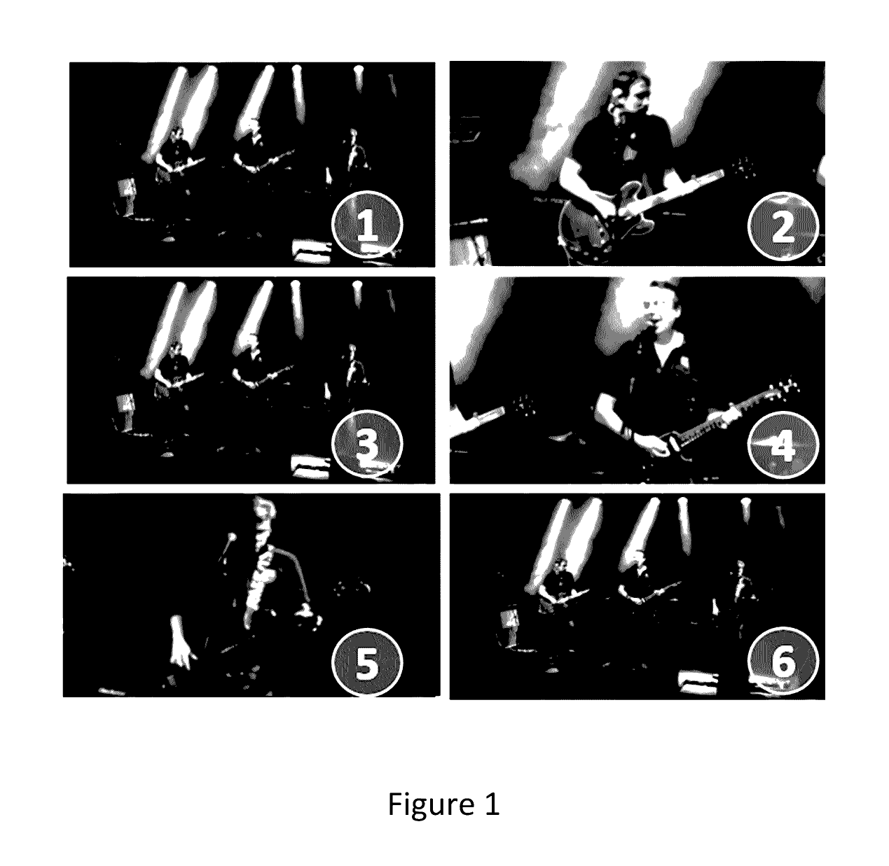

FIGS. 2A-2D illustrate example customized region of interest windows in accordance with an example embodiment of the present invention;

FIG. 3 illustrates an example of fine tuning predicted region of interest windows in accordance with an example embodiment of the present invention;

FIG. 4 illustrates an example of multiple predicted customizations in accordance with an example embodiment of the present invention;

FIG. 5 illustrates an example of neighborhood predictive customization in accordance with an example embodiment of the present invention;

FIG. 6 illustrates a block diagram of an apparatus that may be specifically configured in accordance with example embodiments of the present invention;

FIG. 7 illustrates a block diagram of an example predictive customization system in accordance with an example embodiment of the present invention;

FIG. 8 illustrates a flow chart of operations for an exemplary predictive customization system in accordance with an example embodiment of the present invention;

FIG. 9 illustrates an overview of predictive customization and neighborhood customization in accordance with an example embodiment of the present invention;

FIG. 10 illustrates customization information and neighborhood identifier information that may be signaled in accordance with an example embodiment of the present invention; and

FIG. 11 illustrates an example neighborhood predictive customization module in accordance with example embodiments of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

Methods, apparatuses, and computer program products are provided in accordance with example embodiments of the present invention provide enhanced customization for smart video rendering of high resolution immersive content on devices with lower resolution displays. Embodiments of the present invention provide methods and apparatuses for reducing the number of customizations for creating a smart video rendering with minimal effort. Some types of video content where smart video rendering may be used include high definition video content, wide angle content, immersive video content, 360-degree panoramic (stereoscopic and monoscopic) video, omnidirectional video, and the like. There is no limit upon the resolution.

Embodiments of the present invention may provide a better user experience due to reduction in customization effort. Embodiments may also provide customization prediction with a reduced number of object detectors, which may be achieved by implicit inference of OOIs (e.g., dancer's feet) without actually requiring a specific detector (e.g., a dancer's feet-detector). Embodiments of the present invention may also be better suited to customize longer duration videos by reducing the customization instances

Inheritance Based Customization

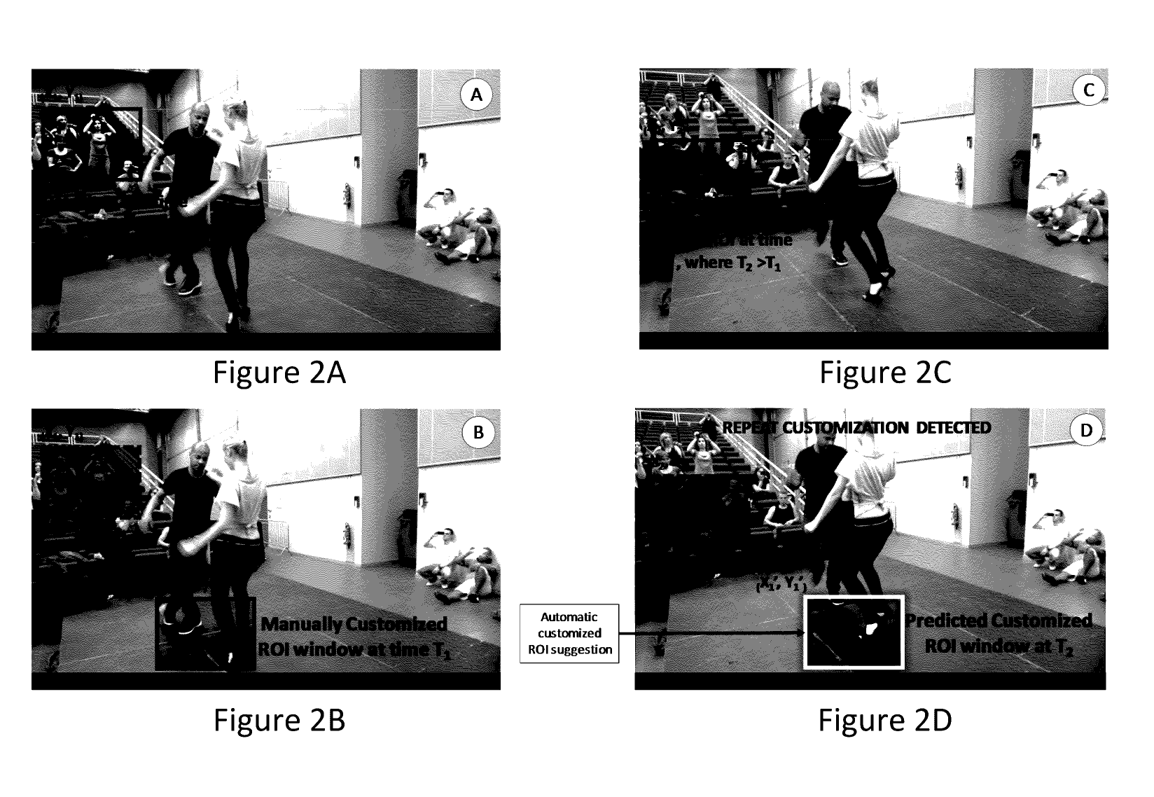

Embodiments of the invention provide for predicting user customizations which are useful for improving the user experience of the automatically generated smart video rendering. In example embodiments, during the customization process, the source and destination coordinates of a first customization are tracked. For example, the spatio-temporal coordinates of the default region of interest (ROI) window and its size selected for rendering are stored, in example embodiments. The user interaction, such as zooming in/zooming out of the ROI window, dragging/dropping the ROI window, or the like, is then stored. The destination spatio-temporal coordinates of the ROI window in the customized position are stored and the object of interest (OOI) position(s) with respect to the default ROI and customized ROI window are stored. FIG. 2A illustrates a default ROI at a first time, T1, and FIG. 2B illustrates a manually customized region of interest at the first time, T1.

At a second time, T2, the user begins to perform a subsequent customization. The spatio-temporal coordinates of the default ROI window during the subsequent customization is determined and a map of the default ROI during the first customization and the OOI position(s) is compared with the default ROI position to be customized currently sequent customization. If the default ROI window and the significant OOI(s) of the subsequent customization are in regions which are at a distance less than a predefined threshold compared to the earlier customizations, the current customization is predicted to be done with a similar motivation (for example to focus on person A instead of person B) as with the earlier customization. The predicted customized ROI of the subsequent customization is determined by finding a region of interest which is in a similar region (spatially) as the one or earlier customization ROI window. FIG. 2C illustrates the default ROI at time T2 (T2>T1) for the subsequent customization and FIG. 2D illustrates the predicted customized ROI window at time T2.

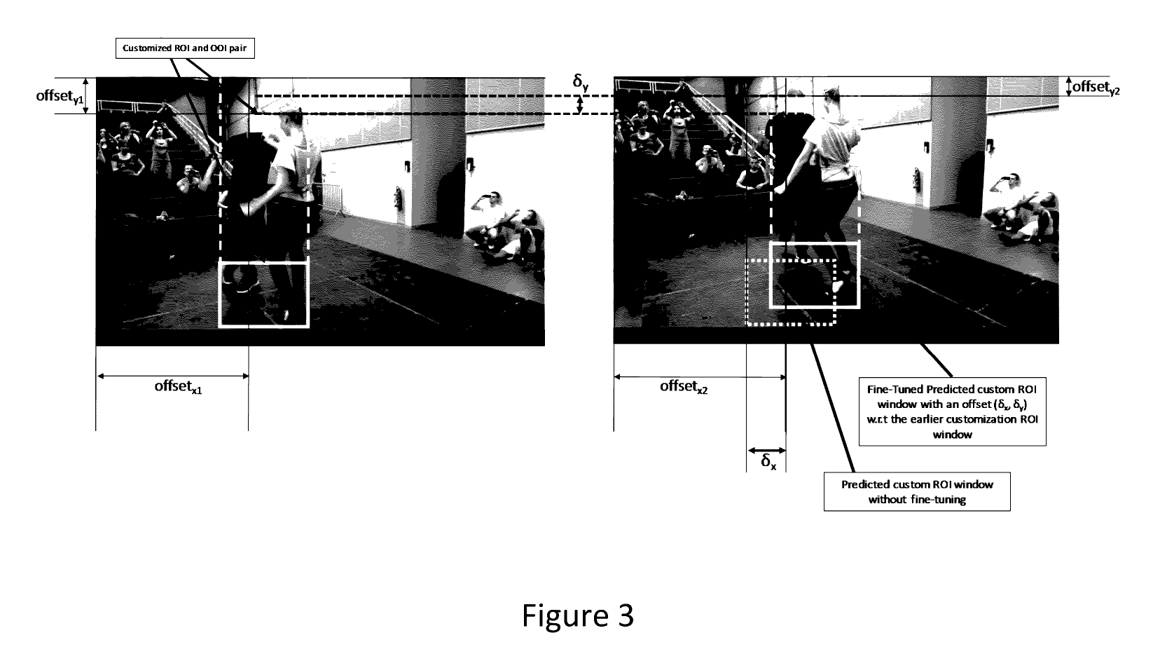

In example embodiments, if the default ROI windows include one or more OOIs, and these OOIs are not excluded by the user during customization, the OOIs are considered to be significant. If one or more customized ROI window(s) are inferred to be connected with an OOI, or part of an OOI, the OOI is considered significant. For example, a customized ROI window may be found to occur for multiple times at a distance below a detected face, or any OOI, as illustrated in FIG. 3. Offsetx1 and Offsety1, illustrated in FIG. 3, are the offsets of the customized ROI window which are used as baseline for the predicted ROI window. In addition, δx and δy, illustrated in FIG. 3, indicate the displacement of the OOI movement which is connected to the customized ROI. Consequently, the baseline predicted ROI window is displaced by the same amount to define the fine-tuned predicted ROI window, in example embodiments.

In example embodiments, the fine-tuned predicted ROI window is derived by using the previously chosen customized ROI windows as a basis and subsequently adjusting the ROI windows to take into account the OOI movements compared to the OOI positions during the earlier customizations. FIG. 3 illustrates a predicted customized ROI window without fine tuning and a fine-tuned predicted customized ROI window in the second (subsequent) frame.

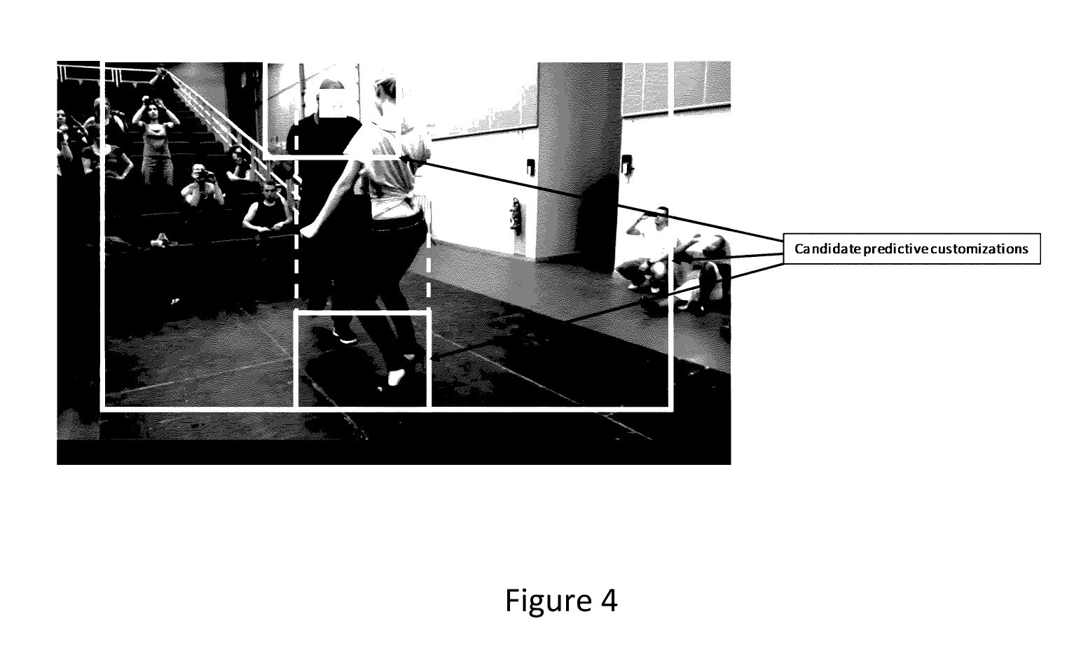

In some embodiments, instead of one single predictive customized view, multiple customized views can be suggested. These may be related to different one or more OOIs connected with the single predictive customization view, as illustrated in FIG. 4. For example, the person (OOI) whose detected face falls under the customized view region in FIG. 3 is the subject of different predictive customization views as illustrated in FIG. 4.

In some embodiments, where object recognition in addition to detection is possible, the customization can be done based on the OOI significance. For example, OOIs which are found to be not excluded during the customization are considered to be or higher significance than those OOIs which are found to be excluded during the customization.

In some embodiments, the prediction of customizations may be done based on the OOI relationship obtained by comparing earlier customizations. If a default ROI window is moved to exclude one or more OOIs and include the other one or more OOIs, for more than a threshold number, it suggests a relationship between the OOIs for customization. For example, a default ROI window includes object A and the customized window for that temporal instance or segment includes object B. If this pattern is repeated for more than a threshold number of temporal instances or segments, a predictive customization may perform similar customizations in the subsequent temporal instances or segments to include object B and exclude object A.

Neighborhood Customization Based on Local Prediction

In the case of omnidirectional content capture capable devices, for example the Nokia Presence Capture (PC) device, there is a high degree of overlap in the field of view among the multiple PC devices which may be present in an event or location of interest (and capturing similar content of the event or location). This implies that the customizations, as well as predictive customizations, performed in one of content captures recorded in the event can be leveraged by other PC devices that recorded content in the event to minimize end user labor. In addition, the high resolution omnidirectional content increases the user load to manually customize multiple temporal segments over large field of view captured by the PC device.

Some embodiments of the invention provide content consumption customization as well as predictive customization to other spatio-temporally overlapping videos in the neighborhood (e.g., same vicinity, same event or location of interest). The multiple videos from the content capture devices in an event or a location of interest (for example touristic point of interest (POI)) may be aligned spatially and/or temporally.

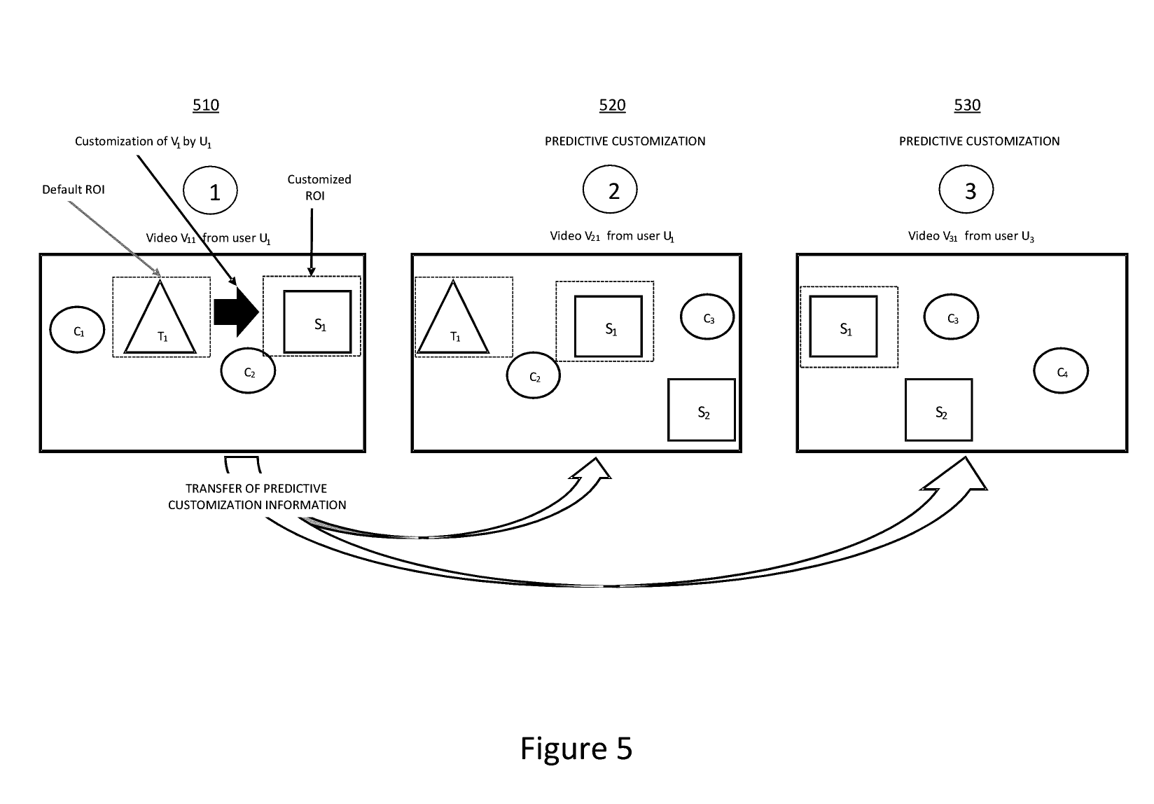

Embodiments provide for the customization of the automatically generated rendering information for the first video to be shared with the neighboring videos (e.g., content captured in the same vicinity, of the same event or location of interest). Subsequently, a user performing local predictive customization (as described above in regard to FIGS. 2-4), can share the predictive customization information to the other content captured in the first video's vicinity, as illustrated in FIG. 5. Consequently, customization of video content (both manual and predictive) may be applied not only to the local video but also to the other videos in the vicinity (neighborhood).

As illustrated in FIG. 5, the video content 510 from a first PC device may be customized as described above. The predictive customization information from the customization of video 510 may then be transferred for use in the predictive customization of other video content in the same vicinity, such as video content 520 and video content 530.

### An Example Apparatus

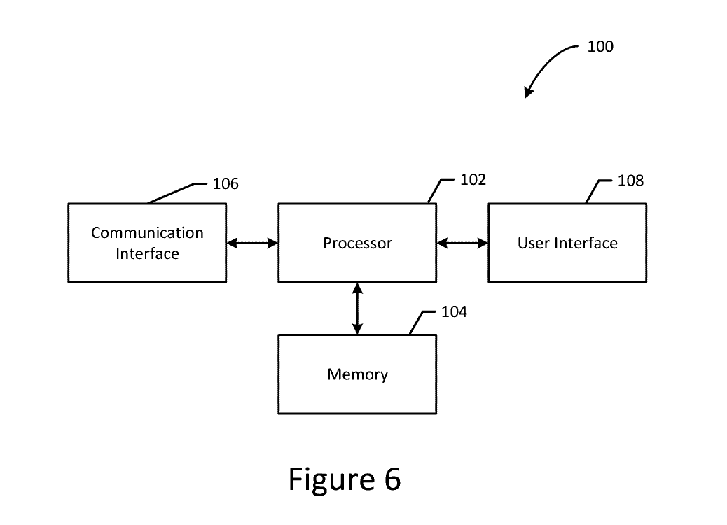

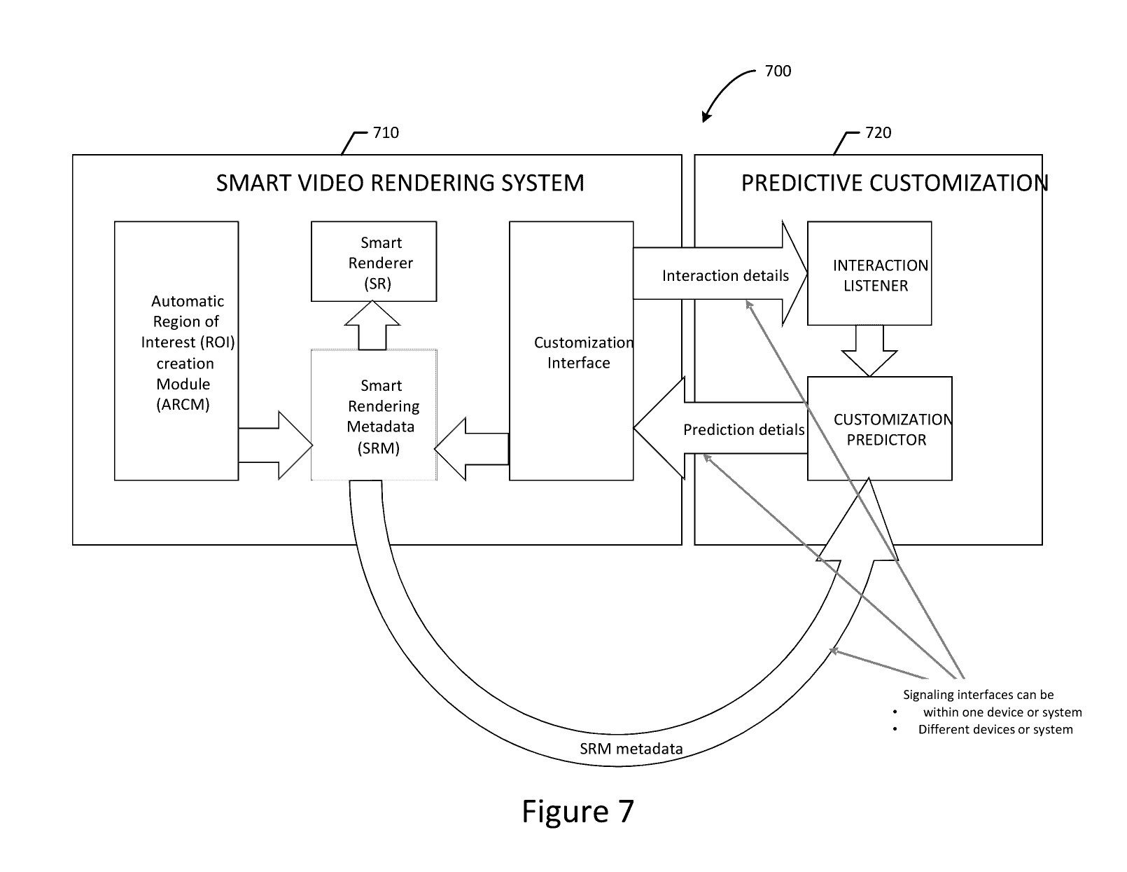

FIG. 6 illustrates an example of an apparatus 100 that may be used in embodiments of the present invention and that may perform one or more of the operations set forth by FIGS. 7-11 described below. It should also be noted that while FIG. 6 illustrates one example of a configuration of an apparatus 100, numerous other configurations may also be used to implement embodiments of the present invention. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

Referring to FIG. 6, the apparatus 100 in accordance with one example embodiment may include or otherwise be in communication with one or more of a processor 102, a memory 102, a communication interface circuitry 106, and user interface circuitry 106.

In some embodiments, the processor (and/or co-processors or any other processing circuitry assisting or otherwise associated with the processor) may be in communication with the memory device via a bus for passing information among components of the apparatus. The memory device may include, for example, a non-transitory memory, such as one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor 102. Additionally or alternatively, the memory device could be configured to store instructions for execution by the processor.

In some embodiments, the apparatus 100 may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 102 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 102 may be configured to execute instructions stored in the memory device 104 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA, or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device configured to employ an embodiment of the present invention by further configuration of the processor by instructions for performing the algorithms and/or operations described herein. The processor may include, among other things, a clock, an arithmetic logic unit (ALU), and logic gates configured to support operation of the processor.

Meanwhile, the communication interface 106 may be any means such as a device or circuitry embodied in either hardware or a combination of hardware and software that is configured to receive and/or transmit data from/to a network and/or any other device or module in communication with the apparatus 100. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

The apparatus 100 may include user interface 108 that may, in turn, be in communication with the processor 102 to provide output to the user and, in some embodiments, to receive an indication of a user input. For example, the user interface may include a display and, in some embodiments, may also include a keyboard, a mouse, a joystick, a touch screen, touch areas, soft keys, a microphone, a speaker, or other input/output mechanisms. The processor may comprise user interface circuitry configured to control at least some functions of one or more user interface elements such as a display and, in some embodiments, a speaker, ringer, microphone, and/or the like. The processor and/or user interface circuitry comprising the processor may be configured to control one or more functions of one or more user interface elements through computer program instructions (e.g., software and/or firmware) stored on a memory accessible to the processor (e.g., memory 104, and/or the like).

Inheritance Based Customization

An implementation of the predictive customization system 700 in an example embodiment is illustrated in FIG. 7. The “Smart Video Rendering System” 710 is the baseline system which does not use predictive customization methods. The baseline system when augmented with the “Predictive Customization” module 720, in accordance with embodiments of the present invention, allows the user to customize the smart video rendering with reduced effort. The smart video rendering system 710 and the predictive customization module 720 of the predictive customization system 700, as well as the signaling interfaces, may be comprised within one device or system, or may comprise different devices or systems in the example embodiments.

In an example embodiment, the smart video rendering system 610 may comprise an automatic ROI creation module, a smart rendering metadata module, a smart renderer module, and a customization interface. The smart video rendering system 710 automatically generates the default ROI windows by analyzing the content. The default ROI windows and the content analysis data are stored in the smart rendering metadata module. The smart rendering metadata data is used by the smart renderer module to render the video. In the smart video rendering system (the baseline system), the user, with the help of the customization interface, can change the default ROI windows to a customized ROI window. (See, for example, FIGS. 2A and 2B, customized ROI window at T1.)

The predictive customization module 620 includes an interaction listener (IL) module and a customization predictor (CP) which keeps track of the customizations. To provide the predictive customization, the user interactions in the smart video rendering system (e.g., customization interface) are signaled to the interaction listener module. In example embodiments, the signaling may comprise the following information:
the spatio-temporal coordinates of the default ROI window and its size selected for rendering;
the user interaction (e.g., zoom-in/out of ROI window, drag, drop, etc.);
the destination spatio-temporal coordinates of the region of interest window in the customized position; and
the OOI position(s) with respect to the default ROI and customized ROI window.
   In addition, the smart video rendering system may signal the smart rendering metadata to the predictive customization system.

The interaction listener module makes the user interaction data available to the customization predictor module. The customization predictor module, by using the smart rendering metadata in addition to the data provided by interaction listener module, determines the customization ROI window for the default ROIs which are likely to be customized by the user in the subsequent temporal segments of the video. The smart rendering metadata may consist of any or all the information generated by the automatic ROI creation module to determine the default ROI window. This may comprise one or more of the following:
Spatio temporal coordinates of the objects of interest in the visual frame; and/or
Temporal coordinates of the audio rhythm (in case of music) or pattern (in case of non-music) content.

The customization predictor module subsequently signals the predicted customization ROI window to the customization interface. This signaling may comprise the following information:
Spatio-temporal coordinates of the predicted customized ROI window or
Spatio-temporal coordinates of multiple predicted customized ROI windows window.

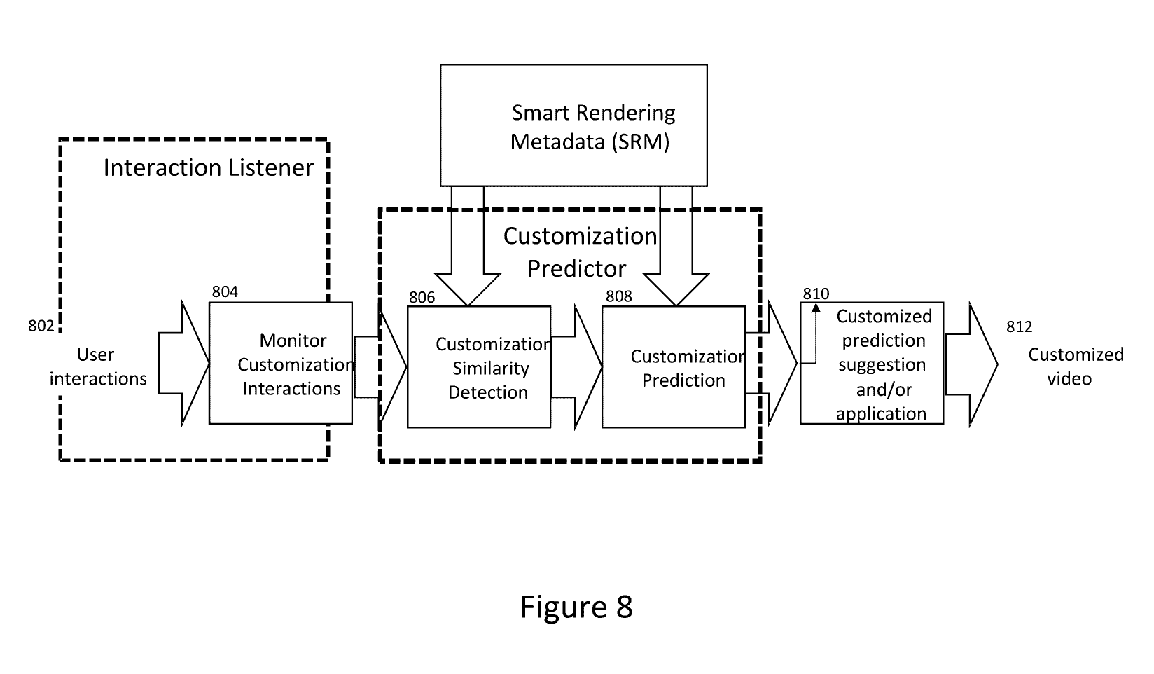

FIG. 8 illustrates an overview of processing operations of an example embodiment of the predictive customization system. At 802, the user interacts with the system, such as by performing customizations through the customization interface. The user interactions are monitored at 804. This involves keeping a record of each customization temporal instance in addition to the spatial movement and resizing.

At 806, customization similarity detection is performed. The customization similarity detection uses the OOI information and default ROI window information (e.g., obtained via the smart rendering metadata module) to detect similarities between customizations (which may occur before and after the current temporal instance, for example). As illustrated in FIGS. 2C and 2D, user customization at T2 may be detected to be similar to the previous customization, for example, at time T1. The process for indicating the detection of a similar customization may be implemented in a suitable manner, depending on the application scenario. For example, in some embodiments, it can be a visual indication, while in other embodiments, it can be a silent annotation.

Subsequently, after determination of a repeat customization (at 806), automatic prediction of the customization ROI window is performed at 808. This may involve finding the significant OOIs that have similar spatial relationships with the default ROI window and the initially customized ROI window, for example see FIG. 3. In FIG. 3, the OOI corresponding to the dancer's face and the customized ROI (corresponding to the dancers' feet) are in a persistent relationship. In this example, the persistent relationship is defined as OOI which occur in the vertical bounds of the customized ROI window. Based on application specific logic, a set of such suitable persistent relationship bounds can be defined. These persistent relationships can be used to generate the OOI and customized ROI window pairs. The customized ROI window position from a previous customization (e.g., a different temporal segment) can be used as a basis for the predicted customization ROI window, and then subsequently fine-tuned by using the OOI relative position in the current frame for which the predictive customization is being done.

At 810, the predicted customized ROI window is indicated in a suitable manner and it is applied based on the application scenario to provide the customized video at 812.

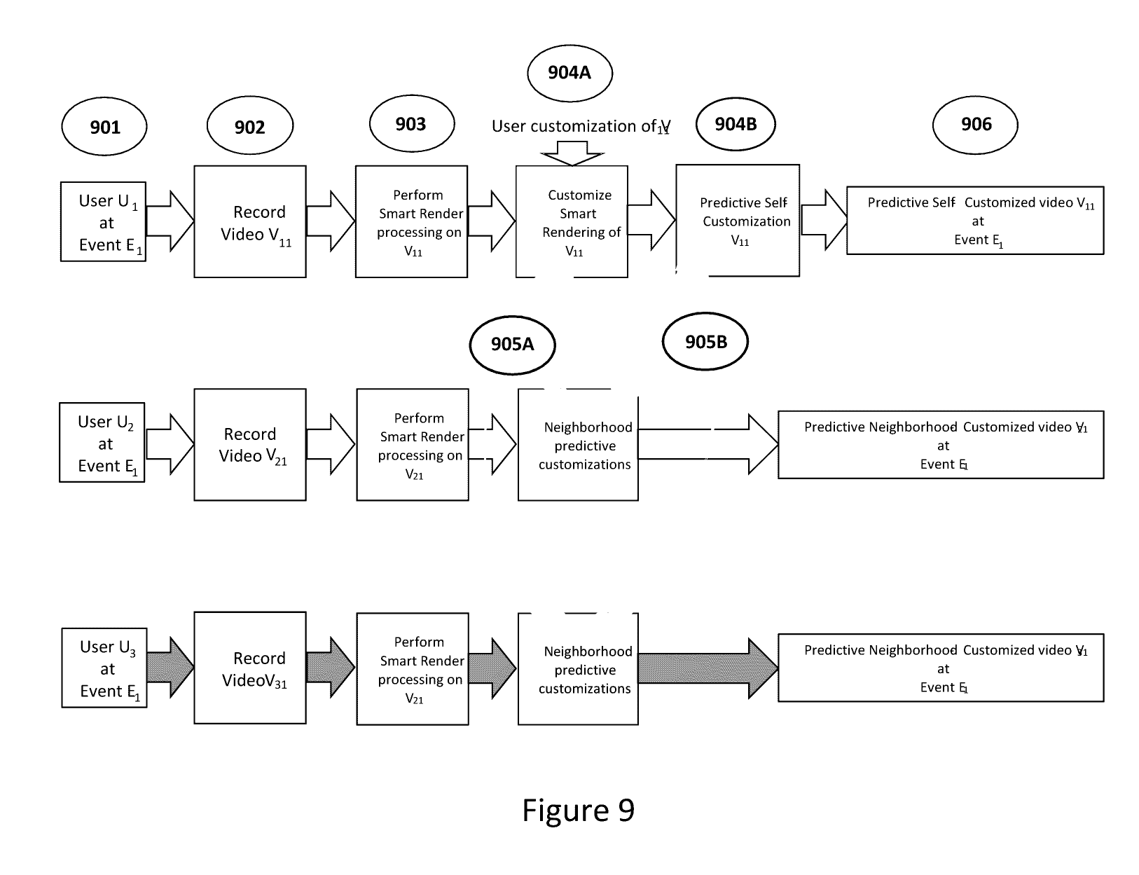

FIG. 9 illustrates an overview of predictive self-customization and neighborhood customization in accordance with example embodiments of the present invention. At 901, users, e.g., users U1, U2, and U3, choose to capture content at an event, e.g., event E1, using a PC device (e.g., capture device with multiple partially overlapping fisheye lenses that cover the 360-degree space) or any other camera device. At 902, content, e.g., video V11, V21, and V31, is recorded by the users and the recorded content is analyzed to determine the spatial and temporal overlap of the content. In example embodiments, any suitable content analysis based or sensor based approach can be used for performing the spatial and temporal alignment. In some embodiments, such as for content related to touristic points of interest (POI), content from different times can also be combined, if the main objects of interest are expected to be static objects (e.g., a monument, statue, etc.).

At 903, smart renderer operations are performed on the captured content, e.g., video V11, V21, and V31, for example as described above. At 904A, the fully automatically generated rendering information for a first user's content, e.g., video V11 of user U1, can be modified interactively based on the user's personal interests. In example embodiments, this can also comprise overriding certain automatically generated choices which may be faulty. At 904B, predictive self-customization of the content, e.g., video V11, can be performed, for example as described above.

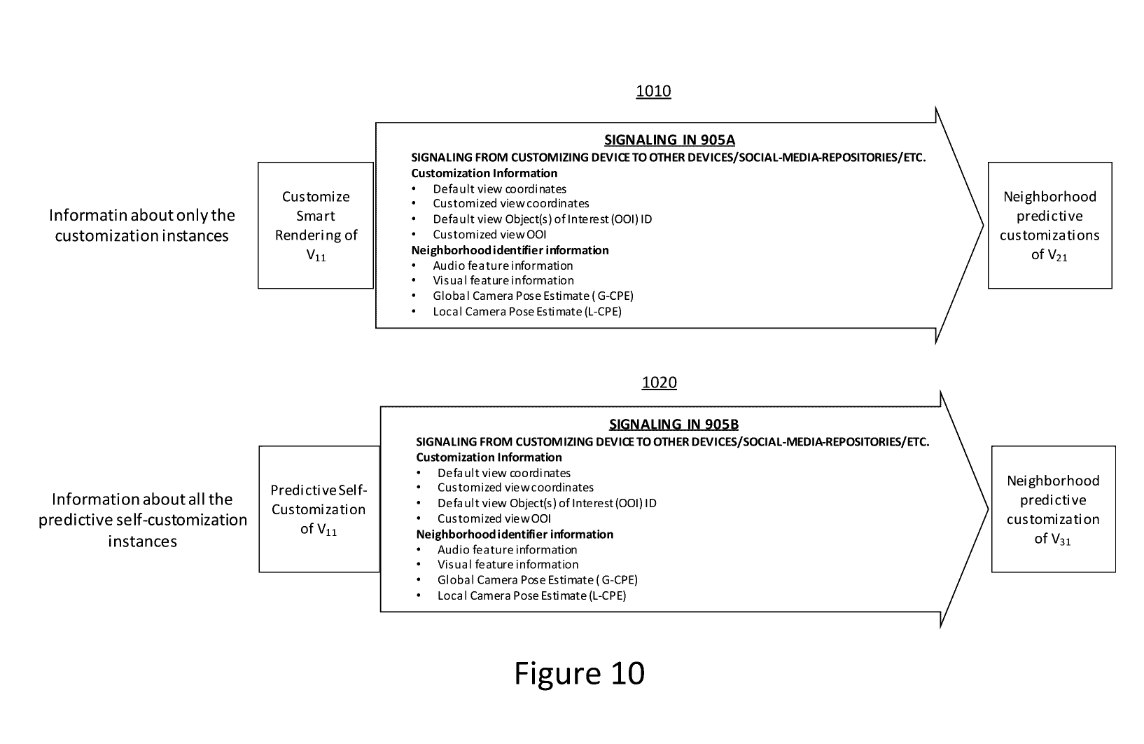

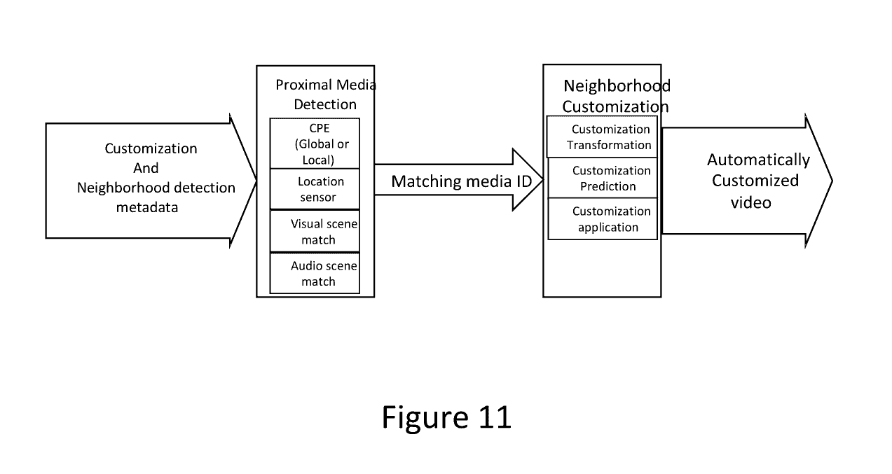

At 905A, the customization information for the customized instances in video V11 can be signaled to the neighborhood devices or devices customizing content recorded in the neighborhood (e.g., in the vicinity, same event or location of interest). This information is leveraged by a neighborhood predictive customizations module, illustrated in FIG. 11. FIG. 10 illustrates example customization information and neighborhood identifier information that may be signaled to the other devices for the customized instances in block 1010. For example, a customizing device (e.g., the device customizing video V11) may signal customization information from the customized instances of the video V11 comprising, for example, default view coordinates, customized view coordinates, default view OOI(s) identification, customized view OOI(s), and the like, to other devices having content recorded in the neighborhood. The customizing device can also signal neighborhood identifier information to other devices comprising, for example, one or more of audio feature information, visual feature information, global camera pose estimate (G-CPE), local camera pose estimate (L-CPE), or the like.

At 905B, the predictive self-customization information for the predictive self-customization instances in video V11 can be signaled to the neighborhood devices or devices customizing content recorded in the neighborhood, e.g., to the neighborhood predictive customizations modules. FIG. 10 illustrates example customization information and neighborhood identifier information that may be signaled to the other devices for the predictive self-customization instances in block 1020. For example, a customizing device (e.g., the device customizing video V11) may signal predictive self-customization information from the self-customized instances of video V11 comprising, for example, default view coordinates, customized view coordinates, default view OOI(s) identification, customized view OOI(s), and the like, to other devices having content recorded in the neighborhood. The customizing device can also signal neighborhood identifier information to other devices comprising, for example, one or more of audio feature information, visual feature information, global camera pose estimate (G-CPE), local camera pose estimate (L-CPE), or the like.

Neighborhood predictive customizations module, illustrated in FIG. 11, may then leverage the signaled information for the customization instances and the predicted self-customization instances from the first content, e.g., video V11, to customize the neighborhood content captured/stored on other devices, e.g. video V21 and V31 for users U2 and U3.

At 906, the predictive self-customized video (customized V11) and the neighborhood-customized video (customized V21 and V31) are provided to the users, and are more likely to provide satisfactory viewing experiences as compared to the original content that does not leverage user inputs.

FIG. 11 illustrates an example neighborhood predictive customization module in accordance with example embodiments. As illustrated in FIG. 11, a neighborhood predictive customization module may comprise proximal media detection and neighborhood customization modules. The neighborhood predictive customization module may receive customization and neighborhood detection metadata from a first device performing customization of captured content, as described above in regard to FIGS. 9 and 10. The proximal media detection module may use the neighborhood identifier information comprised in the customization and neighborhood detection metadata to determine matching media that may be used in the neighborhood customization. The proximal media detection may use data including one or more of G-CPE or L-CPE, location sensor data, visual scene match data, and/or audio scene match data to make the determination. The neighborhood customization module may then use the received customization metadata for the matching media ID to perform customization transformation, customization predication and customization application for the captured content to be customized. The neighborhood customized content may then be provided to the user for viewing.

As described above, FIGS. 8 and 9 illustrate flowcharts of an apparatus, system, method, and computer program product according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 104 of an apparatus employing an embodiment of the present invention and executed by a processor 102 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included, such as shown by the blocks with dashed outlines. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving first instance default region of interest data for a first instance of content;
receiving first instance region of interest customization interaction data for the first instance of the content;
receiving second instance default region of interest data for a second instance of the content;
determining, by a processor, customization similarity detection for the second instance of the content based on the first instance default region of interest data, the first instance region of interest customization interaction data, and the second instance default region of interest data;
generating, by the processor, predicted customized region of interest data for the second instance of the content; and
providing an indication of the predicted customized region of interest data.

2. The method of claim 1, wherein the first instance default region of interest data comprises:
spatio-temporal coordinates of a first instance default region of interest; and
one or more object of interest positions within the first instance default region of interest;
wherein the first instance region of interest customization interaction data comprises:
spatio-temporal coordinates of a first instance customized region of interest; and
one or more object of interest positions within the first instance customized region of interest, and
wherein the second instance default region of interest data comprises:
spatio-temporal coordinates of a second instance default region of interest; and
one or more object of interest positions within the second instance default region of interest.

3. The method of claim 2, wherein determining the customization similarity detection comprises comparing the first instance default region of interest data to the second instance default region of interest data to determine if the first instance default region of interest and the second instance default region of interest are within a threshold distance of each other.

4. The method of claim 3, wherein if the first instance default region of interest and the second instance default region of interest are within a threshold distance of each other, generating predicted customized region of interest data for the second instance comprises determining a region of interest for the second instance which is spatially similar to a customized region of interest for the first instance based on the first instance region of interest customization interaction data.

5. The method of claim 2, further comprising:
determining one or more significant objects of interest in the first instance of content and the second instance of content;
determining a relationship between the one or more significant objects of interest in the first instance and the first instance default region of interest and the first instance customized region of interest; and
modifying a predicted customized region of interest for the second instance based on the relationship and a relative position of the one or more significant objects of interest in the second instance.

6. The method of claim 2, wherein at least one of the first instance default region of interest data or the second instance default region of interest data further comprises temporal coordinates for one of the audio rhythm or the pattern content.

7. The method of claim 1, wherein the predicted customized region of interest data comprises spatio-temporal coordinates of one or more predicted customized regions of interest.

8. An apparatus comprising at least one processor and at least one memory including computer program instructions, the at least one memory and the computer program instructions, with the at least one processor, causing the apparatus at least to:
receive first instance default region of interest data for a first instance of content;
receive first instance region of interest customization interaction data for the first instance of the content;
receive second instance default region of interest data for a second instance of the content;
determine customization similarity detection for the second instance of the content based on the first instance default region of interest data, the first instance region of interest customization interaction data, and the second instance default region of interest data;
generate predicted customized region of interest data for the second instance of the content; and
provide an indication of the predicted customized region of interest data.

9. The apparatus of claim 8, wherein the first instance default region of interest data comprises:
spatio-temporal coordinates of a first instance default region of interest; and
one or more object of interest positions within the first instance default region of interest;
wherein the first instance region of interest customization interaction data comprises:
spatio-temporal coordinates of a first instance customized region of interest; and
one or more object of interest positions within the first instance customized region of interest, and
wherein the second instance default region of interest data comprises:
spatio-temporal coordinates of a second instance default region of interest; and
one or more object of interest positions within the second instance default region of interest.

10. The apparatus of claim 9, wherein the at least one memory and the computer program instructions, with the at least one processor, are configured to cause the apparatus to determine the customization similarity detection by comparing the first instance default region of interest data to the second instance default region of interest data to determine if the first instance default region of interest and the second instance default region of interest are within a threshold distance of each other.

11. The apparatus of claim 10, wherein if the first instance default region of interest and the second instance default region of interest are within a threshold distance of each other, the at least one memory and the computer program instructions, with the at least one processor, are configured to cause the apparatus to generate predicted customized region of interest data for the second instance by determining a region of interest for the second instance which is spatially similar to a customized region of interest for the first instance based on the first instance region of interest customization interaction data.

12. The apparatus of claim 9, wherein the at least one memory and the computer program instructions, with the at least one processor, are further configured to cause the apparatus to:
determine one or more significant objects of interest in the first instance of content and the second instance of content;
determine a relationship between the one or more significant objects of interest in the first instance and the first instance default region of interest and the first instance customized region of interest; and
modify a predicted customized region of interest for the second instance based on the relationship and a relative position of the one or more significant objects of interest in the second instance.

13. The apparatus of claim 9, wherein at least one of the first instance default region of interest data or the second instance default region of interest data further comprises temporal coordinates for one of the audio rhythm or the pattern content.

14. The apparatus of claim 8, wherein the predicted customized region of interest data comprises spatio-temporal coordinates of one or more predicted customized regions of interest.

15. A computer program product comprising at least one non-transitory computer-readable storage medium bearing computer program instructions embodied therein for use with a computer, the computer program instructions comprising program instructions, when executed, causing the computer at least to:
receive first instance default region of interest data for a first instance of content;
receive first instance region of interest customization interaction data for the first instance of the content;
receive second instance default region of interest data for a second instance of the content;
determine customization similarity detection for the second instance of the content based on the first instance default region of interest data, the first instance region of interest customization interaction data, and the second instance default region of interest data;
generate predicted customized region of interest data for the second instance of the content; and
provide an indication of the predicted customized region of interest data.

16. The computer program product of claim 15, wherein the first instance default region of interest data comprises:
spatio-temporal coordinates of a first instance default region of interest; and
one or more object of interest positions within the first instance default region of interest;
wherein the first instance region of interest customization interaction data comprises:
spatio-temporal coordinates of a first instance customized region of interest; and
one or more object of interest positions within the first instance customized region of interest, and
wherein the second instance default region of interest data comprises:
spatio-temporal coordinates of a second instance default region of interest; and
one or more object of interest positions within the second instance default region of interest.

17. The computer program product of claim 16, wherein the program instructions configured to determine the customization similarity detection comprise program instructions which, when executed, cause the computer to compare the first instance default region of interest data to the second instance default region of interest data to determine if the first instance default region of interest and the second instance default region of interest are within a threshold distance of each other.

18. The computer program product of claim 17, wherein if the first instance default region of interest and the second instance default region of interest are within a threshold distance of each other, the program instructions configured to generate predicted customized region of interest data for the second instance comprise program instructions which, when executed, cause the computer to determine a region of interest for the second instance which is spatially similar to a customized region of interest for the first instance based on the first instance region of interest customization interaction data.

19. The computer program product of claim 16, wherein the computer program instructions further comprise program instructions which, when executed, cause the computer to:
determine one or more significant objects of interest in the first instance of content and the second instance of content;
determine a relationship between the one or more significant objects of interest in the first instance and the first instance default region of interest and the first instance customized region of interest; and
modify a predicted customized region of interest for the second instance based on the relationship and a relative position of the one or more significant objects of interest in the second instance.

20. The computer program product of claim 16, wherein at least one of the first instance default region of interest data or the second instance default region of interest data further comprises temporal coordinates for one of the audio rhythm or the pattern content.
